(19) United States
(12) Patent Application Publication
(10) Pub. No.: US 2021/0035523 A1
(43) Pub. Date: Feb. 4, 2021

(54) LIQUID CRYSTAL DISPLAY DEVICE AND DRIVING METHOD THEREOF

(71) Applicant: TCL CHINA STAR OPTOELECTRONICS TECHNOLOGY CO., LTD., Shenzhen (CN)

(72) Inventor: Yanxue WANG, Shenzhen (CN)

(73) Assignee: TCL China Star Optoelectronics Technology Co., Ltd, Shenzhen Guangdong (CN)

(21) Appl. No.: 16/625,723

(22) PCT Filed: May 9, 2019
(86) PCT No.: PCT/CN2019/086182

§ 371 Date: Dec. 22, 2019

(30) Foreign Application Priority Data
Apr. 9, 2019 (CN) 201910280219.4

(51) Int. Cl. G09G 3/36

(52) U.S. Cl. CPC G09G 3/3696; G09G 2310/027; G09G 3/3688; G09G 3/3607

(57) ABSTRACT

Provided are a liquid crystal display device and a driving method thereof. The first pixel holding voltage and the second pixel holding voltage outputted by the positive and negative half-period pixel electrode are not symmetric with respect to the common voltage outputted by the common electrode. Thus, the gray scale inversion of the positive and negative half-period images shown by the liquid crystal display device can be compensated. The skin color whitening problem in side view is improved, thereby solving the viewing angle problem of the liquid crystal display device.

### FIELD OF THE INVENTION

The present application relates to a display technology field, and more particularly to a liquid crystal display device and a driving method thereof.

### BACKGROUND OF THE INVENTION

The Vertical Alignment (VA) liquid crystal display device possesses birefringence characteristics due to the liquid crystal thereof. Compared with the Twisted Nematic (TN) liquid crystal display device, the VA liquid crystal display device is prone to have whitening skin (color washout) problem during display. At present, the commonly used multi-domain pixel design can improve the skin color whitening problem to a certain extent. However, for enhancing the image quality, the viewing angle of the VA liquid crystal display device is still required to be improved.

Therefore, there is a need to provide a technical solution to solve the viewing angle problem of the VA liquid crystal display device.

### SUMMARY OF THE INVENTION

An objective of the present application is to provide a liquid crystal display device and a driving method thereof to solve the viewing angle problem existing during the image display of the liquid crystal display device.

The present application provides a driving method of a liquid crystal display device, wherein the liquid crystal display device includes a pixel electrode and a common electrode;

wherein as the liquid crystal display device shows a Nth frame image, the pixel electrode outputs a first pixel holding voltage, and the common electrode outputs a common voltage;

as the liquid crystal display device shows a N+1th frame image, the pixel electrode outputs a second pixel holding voltage, and the common electrode outputs the common voltage;

wherein an absolute value of a difference between the first pixel holding voltage and the common voltage is not equal to an absolute value of a difference between the second pixel holding voltage and the common voltage, and one of the first pixel holding voltage and the second pixel holding voltage is greater than the common voltage and the other is less than the common voltage, and the number N is an integer greater than zero.

In the aforesaid driving method of the liquid crystal display device, the absolute value of the difference between the first pixel holding voltage and the common voltage is greater than the absolute value of the difference between the second pixel holding voltage and the common voltage.

In the aforesaid driving method of the liquid crystal display device, the absolute value of the difference between the first pixel holding voltage and the common voltage is less than the absolute value of the difference between the second pixel holding voltage and the common voltage.

In the aforesaid driving method of the liquid crystal display device, the first pixel holding voltage and the second pixel holding voltage both are positive.

In the aforesaid driving method of the liquid crystal display device, the liquid crystal display device further includes a common voltage generating circuit, a data driving circuit and a plurality of data lines, and the data driving circuit outputs a data signal to the pixel electrode through the plurality of the data lines to cause the pixel electrode to output the first pixel holding voltage and the second pixel holding voltage, and the common voltage generating circuit outputs a common voltage signal to the common electrode to cause the common electrode to output the common voltage.

The present application further provides a liquid crystal display device, including a pixel electrode and a common electrode; the pixel electrode is configured to output a first pixel holding voltage as the liquid crystal display device shows a Nth frame image, and to output a second pixel holding voltage as the liquid crystal display device shows a N+1th frame image; the common electrode is configured to output a common electrode voltage as the liquid crystal display device shows the Nth frame image and the N+1th frame image;

wherein an absolute value of a difference between the first pixel holding voltage and the common voltage is not equal to an absolute value of a difference between the second pixel holding voltage and the common voltage, and one of the first pixel holding voltage and the second pixel holding voltage is greater than the common voltage and the other is less than the common voltage, and the number N is an integer greater than zero.

In the aforesaid liquid crystal display device, the absolute value of the difference between the first pixel holding voltage and the common voltage is greater than the absolute value of the difference between the second pixel holding voltage and the common voltage.

In the aforesaid liquid crystal display device, the absolute value of the difference between the first pixel holding voltage and the common voltage is less than the absolute value of the difference between the second pixel holding voltage and the common voltage.

In the aforesaid liquid crystal display device, the first pixel holding voltage and the second pixel holding voltage both are positive.

In the aforesaid liquid crystal display device, the liquid crystal display device further includes a common voltage generating circuit, a data driving circuit and a plurality of data lines, and the data driving circuit outputs a data signal to the pixel electrode through the plurality of the data lines to cause the pixel electrode to output the first pixel holding voltage and the second pixel holding voltage, and the common voltage generating circuit outputs a common voltage signal to the common electrode to cause the common electrode to output the common voltage.

In the aforesaid liquid crystal display device, the liquid crystal display device is a vertical alignment liquid crystal display device.

The present application provides a liquid crystal display device and a driving method thereof. The first pixel holding voltage and the second pixel holding voltage outputted by the positive and negative half-period pixel electrode are not symmetric with respect to the common voltage outputted by the common electrode. Thus, the gray scale inversion of the positive and negative half-period images shown by the liquid crystal display device can be compensated. The skin color whitening problem in side view is improved, thereby solving the viewing angle problem of the liquid crystal display device.

### BRIEF DESCRIPTION OF THE DRAWINGS

FIG. 1 is a first waveform diagram of a pixel holding voltage and a common voltage outputted by a pixel electrode and a common electrode of one pixel of a liquid crystal display device of the present application;

FIG. 2 is a diagram of liquid crystal deflection when the output waveform of the pixel electrode and the common electrode of the liquid crystal display device of the present application is shown in FIG. 1;

FIG. 3 is a waveform diagram of a pixel holding voltage and a common voltage outputted by a pixel electrode and a common electrode of one pixel of a liquid crystal display device of the prior art;

FIG. 4 is a diagram of liquid crystal deflection when the output waveform of the pixel electrode and the common electrode of the liquid crystal display device is shown in FIG. 3;

FIG. 5 is a perspective view diagram that the output waveforms of the pixel electrode and the common electrode of the liquid crystal display device is shown in FIGS. 1 and 3 to show a skin color of an African woman;

FIG. 6 is a perspective view diagram that the output waveforms of the pixel electrode and the common electrode of the liquid crystal display device is shown in FIGS. 1 and 3 to show a skin color of a Caucasian;

FIG. 7 is a perspective view diagram that the output waveforms of the pixel electrode and the common electrode of the liquid crystal display device is shown in FIGS. 1 and 3 to show a skin color of an Asian female;

FIG. 8 is a second waveform diagram of a pixel holding voltage and a common voltage outputted by a pixel electrode and a common electrode of one pixel of a liquid crystal display device of the present application.

### DETAILED DESCRIPTION OF PREFERRED EMBODIMENTS

For better explaining the technical solution and the effect of the present invention, the present invention will be further described in detail with the accompanying drawings in the specific embodiments. It is clear that the described embodiments are merely part of embodiments of the present application, but not all embodiments. Based on the embodiments of the present application, all other embodiments to those of skilled in the premise of no creative efforts obtained, should be considered within the scope of protection of the present application.

The present application provides a driving method of a liquid crystal display device. The liquid crystal display device is a vertical alignment liquid crystal display device. The liquid crystal display device includes an array substrate, a color filter substrate disposed opposite to the array substrate and liquid crystal disposed between the array substrate and the color filter substrate. The array substrate is provided with a pixel electrode, and the color film substrate is provided with a common electrode.

As the liquid crystal display device shows a Nth frame image, the pixel electrode outputs a first pixel holding voltage, and the common electrode outputs a common voltage.

As the liquid crystal display device shows a N+1th frame image, the pixel electrode outputs a second pixel holding voltage, and the common electrode outputs a common voltage.

An absolute value of a difference between the first pixel holding voltage and the common voltage is not equal to an absolute value of a difference between the second pixel holding voltage and the common voltage, and one of the first pixel holding voltage and the second pixel holding voltage is greater than the common voltage and the other is less than the common voltage, and the number N is an integer greater than zero.

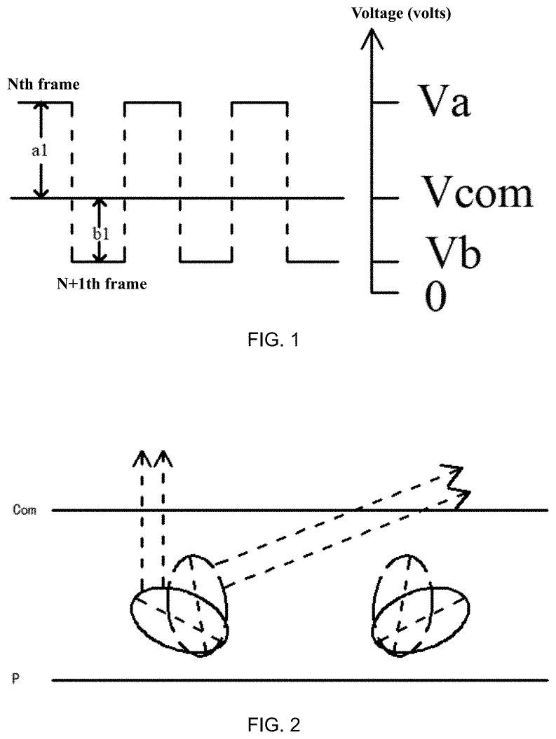

As shown in FIG. 1, FIG. 1 is a first waveform diagram of a pixel holding voltage and a common voltage outputted by a pixel electrode and a common electrode of one pixel of a liquid crystal display device of the present application, and FIG. 2 is a diagram of liquid crystal deflection when the output waveform of the pixel electrode and the common electrode of the liquid crystal display device of the present application is shown in FIG. 1. The absolute value al of the difference between the first pixel holding voltage Va and the common voltage Vcom as the Nth frame image is shown is not equal to the absolute value b1 of a difference between the second pixel holding voltage Vb and the common voltage Vcom as the N+1th frame image is shown. Specifically, the absolute value al of the difference between the first pixel holding voltage Va and the common voltage Vcom is greater than the absolute value b1 of a difference between the second pixel holding voltage Vb and the common voltage Vcom. The first pixel holding voltage Va and the second pixel holding voltage Vb both are positive. Therefore, the deflected angles of the liquid crystal molecules (shown by the solid line) when the Nth frame image is displayed are different from the deflected angles of the liquid crystal molecules (shown by the broken line) when the of the N+1th frame image is displayed. When the Nth frame image and the N+1th frame image displayed by the liquid crystal display device are viewed from the side, the gray scale inversion of the Nth frame image and the N+1th frame image is compensated. The skin color whitening problem can be improved, thereby solving the viewing angle problem of the liquid crystal display device.

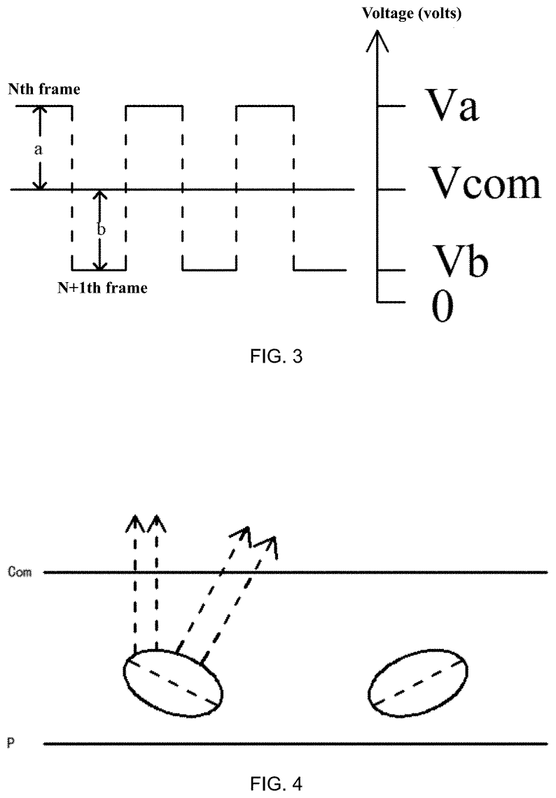

As shown in FIG. 3 and FIG. 4, FIG. 3 is a waveform diagram of a pixel holding voltage and a common voltage outputted by a pixel electrode and a common electrode of one pixel of a liquid crystal display device of the prior art, and FIG. 4 is a diagram of liquid crystal deflection when the output waveform of the pixel electrode and the common electrode of the liquid crystal display device is shown in FIG. 3. In the prior art, as the liquid crystal display device displays the Nth frame image and the N+1th frame image, the pixel holding voltages (Va and Vb) outputted from the pixel electrode P are symmetrical with respect to the common voltage (Vcom) outputted from the common electrode Com. Namely, the absolute value a of the difference between the first pixel holding voltage Va and the common voltage Vcom as the Nth frame image is shown is equal to the absolute value b of a difference between the second pixel holding voltage Vb and the common voltage Vcom as the N+1th frame image is shown. Thus, when the Nth frame image and the N+1th frame image are displayed, the deflection states of the liquid crystal are the same. The liquid crystal is birefringent crystal, thus in the front view and in the side view, the deflection states of the liquid crystal are different, and the gray scale brightness inversion may be easy to occur.

Since the actual pixel holding voltage of the liquid crystal display device cannot be detected by the instrument, the external performance of the positive and negative half-period (the Nth frame and the N+1th frame are one period, the Nth frame is the positive half period, and the N+1th frame is the negative half period) of the symmetrical state of the pixel holding voltage and the common voltage is the flicker value of the liquid crystal display device. When the flicker value is smaller, the pixel hold voltage and the common voltage of the positive and negative half-period are more symmetric. By adjusting the input end gamma (P-gamma) voltage signal and the common voltage signal, the CA-310 color analyzer is used to observe the change of the flicker value, and then the symmetric relationship between the pixel holding voltage outputted by the pixel electrode and the common voltage outputted by the common electrode can be obtained.

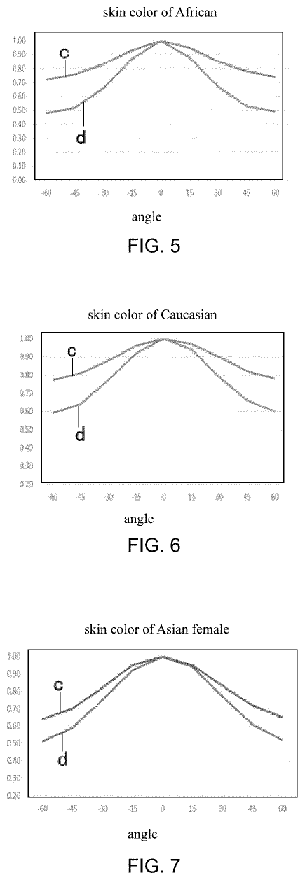

As shown in FIG. 5 to FIG. 7, FIG. 5 is a perspective view diagram that the output waveforms of the pixel electrode and the common electrode of the liquid crystal display device is shown in FIGS. 1 and 3 to show a skin color of an African female, and FIG. 6 is a perspective view diagram that the output waveforms of the pixel electrode and the common electrode of the liquid crystal display device is shown in FIGS. 1 and 3 to show a skin color of a Caucasian, and FIG. 7 is a perspective view diagram that the output waveforms of the pixel electrode and the common electrode of the liquid crystal display device is shown in FIGS. 1 and 3 to show a skin color of an Asian female. The abscissas of FIGS. 5-7 represent the angle (viewing angle). The ordinates of FIGS. 5-7 represent the ratio of the hue (color saturation) at different angles to the hue at an angle of 0. The angle 0 is the angle right facing the liquid crystal display device. As shown in FIGS. 5-7, when the absolute value of the left-view angle (−60 degrees to 0 degrees) and the absolute value of the right-view angle (0 degrees to 60 degrees) are the same, the ratio of the hue corresponding to the left view and the hue corresponding to the angle 0 is equal to ratio of the hue corresponding to the right view and the hue corresponding to the angle 0; as the angle increases from 0 degrees to 60 degrees or decreases from 0 degrees to −60 degrees, the value of the ordinate gradually decreases. It indicates that the larger the absolute value of the difference between the side view angle and the front view angle, the more the hue drops. Besides, the flicker value of the curve c is greater than the flicker value of the curve d, and the curve c is a curve corresponding to the waveform shown in FIG. 1, and the curve d is a curve corresponding to the waveform shown in FIG. 3. When the side view angles are the same, the ordinate of curve c is greater than the ordinate of curve d. Namely, the hue value corresponding to the curve c is greater than the hue value corresponding to the curve d. It indicates that in side view, the viewing angle when the pixel electrode and the common electrode of the liquid crystal display device output the waveform shown in FIG. 1 is better than the viewing angle when the pixel electrode and the common electrode of the liquid crystal display device output the waveform shown in FIG. 3.

In driving method of the liquid crystal display device of the present application, the first pixel holding voltage and the second pixel holding voltage outputted by the positive and negative half-period pixel electrode are not symmetric with respect to the common voltage outputted by the common electrode. Thus, the gray scale inversion of the positive and negative half-period images shown by the liquid crystal display device can be compensated. The skin color whitening problem in side view is improved, thereby solving the viewing angle problem of the liquid crystal display device.

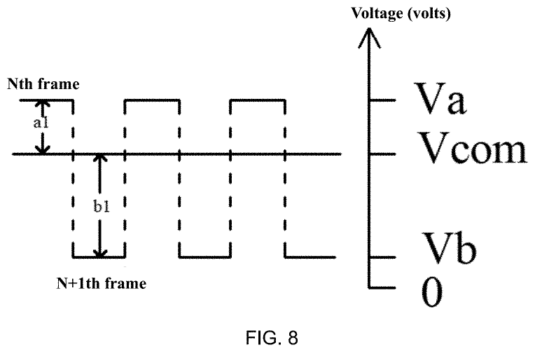

As shown in FIG. 8, provided is a second waveform diagram of a pixel holding voltage and a common voltage outputted by a pixel electrode and a common electrode of one pixel of a liquid crystal display device of the present application. The waveform diagram shown in FIG. 8 is basically similar to the waveform diagram shown in FIG. 1, except that the absolute value al of the difference between the first pixel holding voltage Va and the common voltage Vcom is less than the absolute value b1 of the difference between the second pixel holding voltage Vb and the common voltage Vcom.

Furthermore, the liquid crystal display device further includes a common voltage generating circuit, a data driving circuit and a plurality of data lines, and the data driving circuit outputs a data signal to the pixel electrode through the plurality of the data lines to cause the pixel electrode to output the first pixel holding voltage and the second pixel holding voltage, and the common voltage generating circuit outputs a common voltage signal to the common electrode to cause the common electrode to output the common voltage.

The present application further provides a liquid crystal display device, including a pixel electrode and a common electrode. The pixel electrode is configured to output a first pixel holding voltage as the liquid crystal display device shows a Nth frame image, and to output a second pixel holding voltage as the liquid crystal display device shows a N+1th frame image. The common electrode is configured to output a common electrode voltage as the liquid crystal display device shows the Nth frame image and the N+1th frame image.

An absolute value of a difference between the first pixel holding voltage and the common voltage is not equal to an absolute value of a difference between the second pixel holding voltage and the common voltage, and one of the first pixel holding voltage and the second pixel holding voltage is greater than the common voltage and the other is less than the common voltage, and the number N is an integer greater than zero.

Furthermore, the absolute value of the difference between the first pixel holding voltage and the common voltage is greater than the absolute value of the difference between the second pixel holding voltage and the common voltage. Alternatively, the absolute value of the difference between the first pixel holding voltage and the common voltage is less than the absolute value of the difference between the second pixel holding voltage and the common voltage. The first pixel holding voltage and the second pixel holding voltage both are positive.

Furthermore, the liquid crystal display device further includes a common voltage generating circuit, a data driving circuit and a plurality of data lines, and the data driving circuit outputs a data signal to the pixel electrode through the plurality of the data lines to cause the pixel electrode to output the first pixel holding voltage and the second pixel holding voltage, and the common voltage generating circuit outputs a common voltage signal to the common electrode to cause the common electrode to output the common voltage.

In the liquid crystal display device of the present application, the first pixel holding voltage and the second pixel holding voltage outputted by the positive and negative half-period pixel electrode are not symmetric with respect to the common voltage outputted by the common electrode. Thus, the gray scale inversion of the positive and negative half-period images shown by the liquid crystal display device can be compensated. The skin color whitening problem in side view is improved, thereby solving the viewing angle problem of the liquid crystal display device.

The description of the foregoing embodiments is merely for helping to understand the technical solutions of the present application and the core ideas thereof; those skilled in the art should understand that the technical solutions described in the foregoing embodiments may be modified, or some of the technical features may be equivalently replaced; and the modifications or replacements do not deviate from the spirit and scope of the technical solutions of the embodiments of the present application.

What is claimed is:

1. A driving method of a liquid crystal display device, wherein the liquid crystal display device includes a pixel electrode and a common electrode;
wherein as the liquid crystal display device shows a Nth frame image, the pixel electrode outputs a first pixel holding voltage, and the common electrode outputs a common voltage;
as the liquid crystal display device shows a N+1th frame image, the pixel electrode outputs a second pixel holding voltage, and the common electrode outputs the common voltage;
wherein an absolute value of a difference between the first pixel holding voltage and the common voltage is not equal to an absolute value of a difference between the second pixel holding voltage and the common voltage, and one of the first pixel holding voltage and the second pixel holding voltage is greater than the common voltage and the other is less than the common voltage, and the number N is an integer greater than zero.

2. The driving method of the liquid crystal display device according to claim 1, wherein the absolute value of the difference between the first pixel holding voltage and the common voltage is greater than the absolute value of the difference between the second pixel holding voltage and the common voltage.

3. The driving method of the liquid crystal display device according to claim 1, wherein the absolute value of the difference between the first pixel holding voltage and the common voltage is less than the absolute value of the difference between the second pixel holding voltage and the common voltage.

4. The driving method of the liquid crystal display device according to claim 1, wherein the first pixel holding voltage and the second pixel holding voltage both are positive.

5. The driving method of the liquid crystal display device according to claim 1, wherein the liquid crystal display device further includes a common voltage generating circuit, a data driving circuit and a plurality of data lines, and the data driving circuit outputs a data signal to the pixel electrode through the plurality of the data lines to cause the pixel electrode to output the first pixel holding voltage and the second pixel holding voltage, and the common voltage generating circuit outputs a common voltage signal to the common electrode to cause the common electrode to output the common voltage.

6. A liquid crystal display device, including a pixel electrode and a common electrode; the pixel electrode is configured to output a first pixel holding voltage as the liquid crystal display device shows a Nth frame image, and to output a second pixel holding voltage as the liquid crystal display device shows a N+1th frame image; the common electrode is configured to output a common electrode voltage as the liquid crystal display device shows the Nth frame image and the N+1th frame image;
wherein an absolute value of a difference between the first pixel holding voltage and the common voltage is not equal to an absolute value of a difference between the second pixel holding voltage and the common voltage, and one of the first pixel holding voltage and the second pixel holding voltage is greater than the common voltage and the other is less than the common voltage, and the number N is an integer greater than zero.

7. The liquid crystal display device according to claim 6, wherein the absolute value of the difference between the first pixel holding voltage and the common voltage is greater than the absolute value of the difference between the second pixel holding voltage and the common voltage.

8. The liquid crystal display device according to claim 6, wherein the absolute value of the difference between the first pixel holding voltage and the common voltage is less than the absolute value of the difference between the second pixel holding voltage and the common voltage.

9. The liquid crystal display device according to claim 6, wherein the first pixel holding voltage and the second pixel holding voltage both are positive.

10. The liquid crystal display device according to claim 6, wherein the liquid crystal display device further includes a common voltage generating circuit, a data driving circuit and a plurality of data lines, and the data driving circuit outputs a data signal to the pixel electrode through the plurality of the data lines to cause the pixel electrode to output the first pixel holding voltage and the second pixel holding voltage, and the common voltage generating circuit outputs a common voltage signal to the common electrode to cause the common electrode to output the common voltage.

11. The liquid crystal display device according to claim 6, wherein the liquid crystal display device is a vertical alignment liquid crystal display device.
